(19) United States
(12) Patent Application Publication
(10) Pub. No.: US 2009/0102924 A1
(43) Pub. Date: Apr. 23, 2009

(54) Rapidly Deployable, Remotely Observable Video Monitoring System

(76) Inventor: James W. Masten, JR., (US)

Correspondence Address: James W. Masten, Jr., 8528-14th Ave. NW, Seattle, WA, 98117, US

(21) Appl. No.: 12/124,549

(22) Filed: May 21, 2008

Related U.S. Application Data
(60) Provisional application No. 60/939,319, filed on May 21, 2007.

(51) Int. Cl. H04N 7/18

(52) U.S. Cl. 348/155; 348/E07.085

(57) ABSTRACT

A panoramic imaging threat detection and alert system to automate the detection, localization, tracking and assessment of moving objects within a specified field of view. This system utilizes an array of large-scale imaging chips, an array of reflective lenses coded for computational imaging, passive distance measurement and high-speed processors to determine the characteristics of objects of interest. This system selects moving objects to further evaluate for threat assessment and communicates object size, speed, distance and acceleration to a designated threat assessment center or personnel for further action.

### CROSS-REFERENCES TO RELATED APPLICATIONS

This application claims priority to U.S. Provisional Application 60/939,319 filed on May 21, 2007, which itself claims priority to U.S. Provisional Application 60/917,049, filed on May 9, 2007. The foregoing applications are hereby incorporated by reference in their entirety as if fully set forth herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

The world situation requires constant vigilance against a variety of threats. Social scientists may argue that as distances shrink and populations grow, conflict at many levels would be inevitable. Whatever the cause or the reason, most of a nation's assets now require monitoring as a protection against some kind of threat by internal, external, foreign or domestic human forces. The results are a current need to monitor borders, pipelines, reservoirs, ports (both air and water), buildings, energy stores (oil, gas, hydro, electric, etc.) and other natural or man-made constructions of national value. In fact, sometimes the protected entity will be just the population at a sporting event or at work, or just gathered in one place, such as commuting on a highway.

The first efforts at monitored protection have been efforts such as the British effort at fixed installed cameras. The cameras provide remote observation but require a human effort at the monitored end of the system to detect an alert and enable prevention. Otherwise, the system only provides a recorded video history as a beginning of the effort to discover the identity or exact means used by the perpetrators.

Another aspect of the problems of the fixed camera technology as currently used is the lack of sufficient coverage. Cameras with sufficient resolution to enable some forms of automatic alert or threat identification would have very limited fields of view. So, the numbers of cameras required for sufficient coverage would be extremely large.

This large number of installed cameras brings yet another complexity: the required connection bandwidth to bring all of that video back to the head-end for monitoring by a now extremely large number of human monitors or a very large analytic computer to provide the automated alert functions. As the complexity and the number of areas to be monitored grow, a system is needed which will manage the complexity and decrease the burden on these human monitors and responders: a system with the technology and the tools to allow for more reliable threat detection and assessment.

### BRIEF SUMMARY OF THE INVENTION

The invention described herein is an affordable, massively parallel camera system that provides sufficient resolution over a complete panoramic view to support threat detection and assessment. This invention is a system of software programs, unique electronic hardware components and a system of fixed reflective lenses. This invention implements a known technology, a “staring array,” using new technology imaging and lens components incorporated into a hierarchical architecture of massively parallel sub-systems. This apparatus is capable of operating in several modes, including a fully automatic threat detection, assessment and alert configuration. In this mode the device can monitor large areas of coverage, conceivably up to a full 360° panorama.

The implementation can be tailored to fit many situations, from providing complete coverage for a small office, to protecting large assets isolated in open terrain. More or fewer parallel sub-systems can be ganged together to create a camera system that will deliver automated threat detection and alert to properly configured reactive personnel.

This is a very different supporting construction from traditional video monitoring systems. As confidence grows in the automated detection technology, the force-multiplying effects will enable reactive personnel to cover very large areas. By this means, the system will dramatically enhance the value of the resources spent where they are the most effective, on reactive forces directly countering the threats to our national assets. And the system will minimize the expenditures of resources where they are the least effective: monitoring personnel that can't possibly cover the large number of monitoring points required.

### BRIEF DESCRIPTION OF THE DRAWINGS

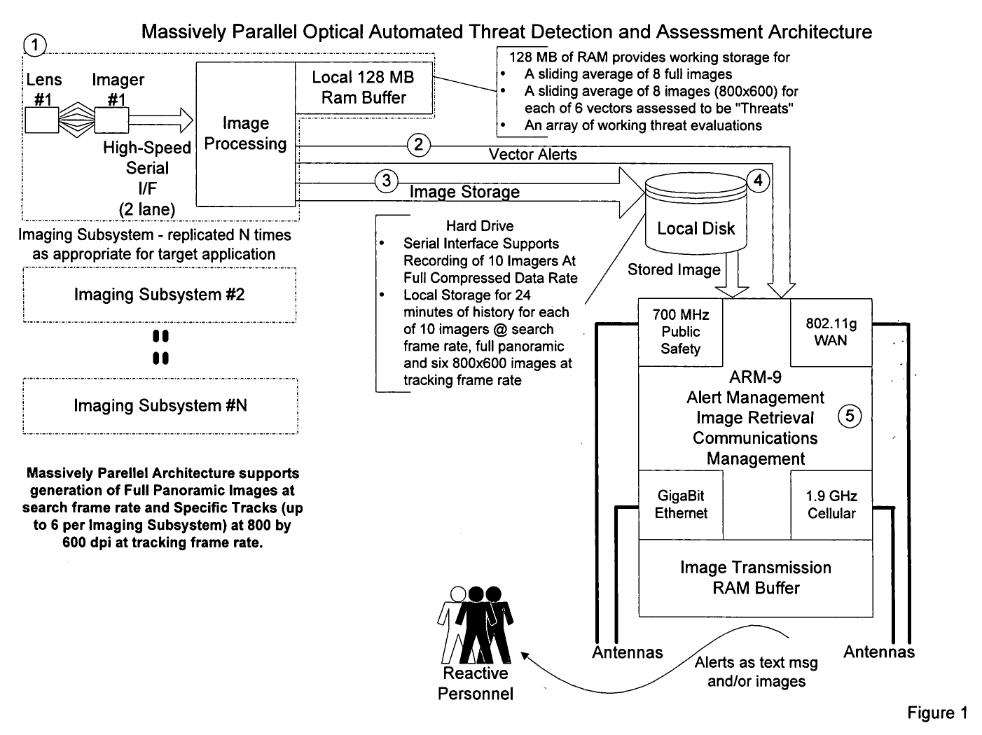

### FIG. 1

### Massively Parallel Optical Automated Threat Detection and Assessment Architecture

FIG. 1 illustrates the physical architecture of the Massively Parallel Optical Automated Threat Detection and Assessment System.

Item 1 represents the Imaging Subsystem comprising the lens, the image detection chip, the high speed differential serial interface bus to the image processing FPGA, and the FPGA image processing unit with local RAM storage. The local RAM storage provides a circular buffer for multiple full panoramic image components from this Imaging Subsystem, as well as accommodating circular buffers for each of the 6 tracks that can be managed in the processing resources of each imager.

Item 2 represents the high-speed differential serial bus that links the vector alert status to the Management unit (Item 5).

Item 3 represents the high-speed differential serial bus to the hard drive unit between the FPGA processor and the hard drive units.

Item 4 represents the hard disk resource that provides short-term video data storage for multiple Imaging Subsystems (nominally, a 200 GB storage unit will support up to 10 imaging sub-systems).

Item 5 represents the management unit. The management units may be hierarchically organized to manage multiple Imaging Subsystems and report up and down the chain to effect timely alerts and to evaluate alert responses against a time-line decision table. The management units are not tasked with any image processing responsibilities, but rather they are the link between the automatic threat detection and the “Reactive Personnel” charged with neutralizing or compromising the threat.

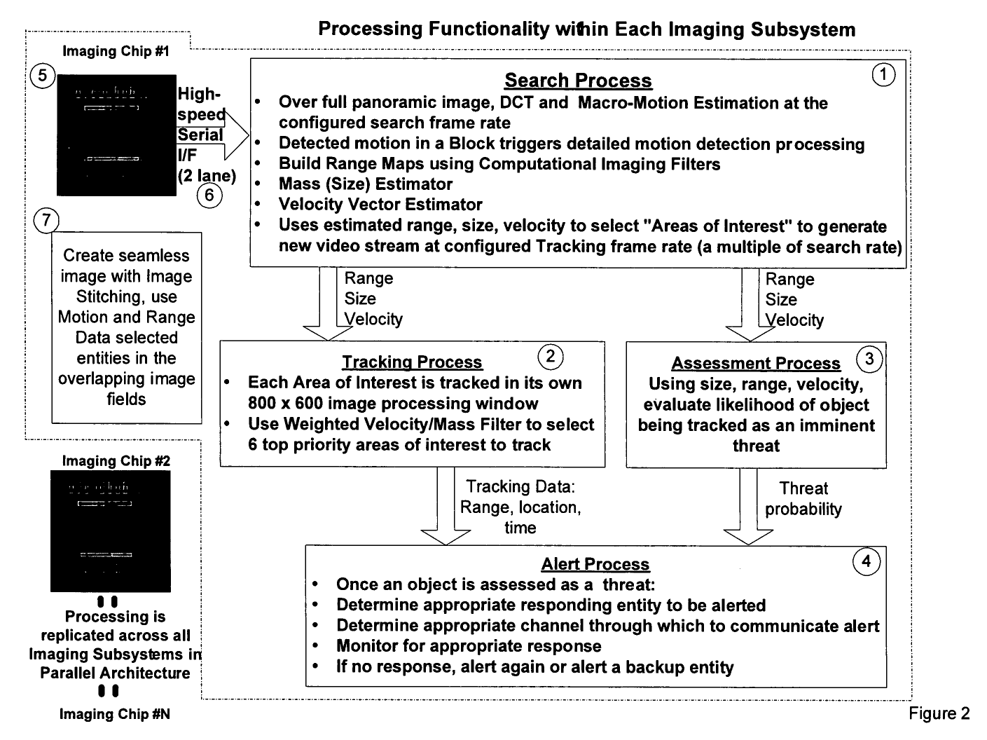

### FIG. 2

### Processing Functionality within Each Imaging Subsystem

In this implementation, each imaging chip (nominally a Micron 9 Mega-Pixel chip) feeds a portion of the process. Six of the 7 processing blocks are repeated for every imaging chip in the array.

Block 7 is used to process the overlapping images to form a stitched image of the adjacent image chips. Block 7 is repeated for every additional image chip to extend the image to (potentially) a full panoramic image.

Block 1: The search process is performed in parallel over the full panoramic scene in sections by imaging chip at a configurable “search rate,” nominally 5 fps. This is the basic preparatory processing in spatial, temporal and frequency modes. In this block, circular buffers are constructed of configurable length to enable course (large block) comparisons for movement. When a motion detection is made, more fidelity of the detection is provided though Size Estimators and Velocity Estimators. Velocity Estimators from Computational Imaging use the spatially or wave-coded filters in the lens optical path.

Block 2: Detections are tracked at a “tracking rate,” nominally 30 fps. The detections are tracked using a finer-grain comparison block and validated using Computational Imaging to create an updated Velocity Vector Map.

Block 3: Tracks are constantly “Assessed” against a “Threat Matrix” as an aid to the decision process that can classify a “Track” as a Threat, which can cause an alert to be transmitted. The Threat Assessment rules are configurable and range from physical barrier transgression, excessive size and position, to ground coupling anomalies (e.g., where a man carrying a heavy load loses the bounce in his step).

Block 4: This process manages the Alert transmission and response conformation. This process follows a defined, configurable Alert Matrix to inform the proper responding entity and confirm a response within a time and encroachment barrier.

Block 5: The Imaging chip is a nominal multi-Mega-pixel CMOS imager. Current, typical imaging chip might be the Micron 9 Mega-Pixel imager with built-in image adapting technology. This chip adds a new instruction set that enables some of the image configuration that is traditionally done off-chip in software.

Block 6 is a typical, high speed, differential serial bus between the image chip and the FPGA processor. There is a similar bus connecting the SATA disk drive to the FPGA.

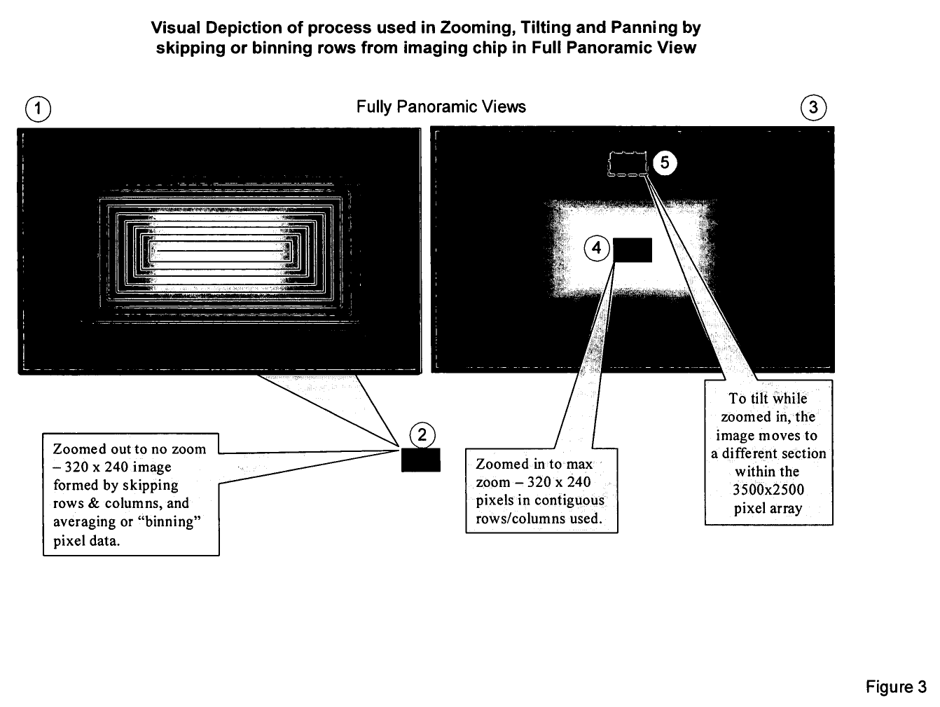

### FIG. 3

### Visual Depiction of Process Used in Zooming Tilting and Panning by Skipping or Binning Rows from Imaging Chip in Full Panoramic View

FIG. 3 depicts two panoramic views, each across multiple Mega-pixel Imaging Subsystems.

Item 1 depicts how a “zoomed out” image is made from visible light gathered from all over the panoramic array. Rows and columns are selected and others are skipped or averaged and totaled to become the next row or column. This way a zoomed out or wide view transportable image (Item 2) is built using energy from all over the array.

Item 3 depicts how a “zoomed in” image is built using contiguous rows and columns to build a transportable image (Item 4).

Item 5 illustrates how tilt, while zoomed in, moves the contiguous transportable image up the large array to a different vertical perspective.

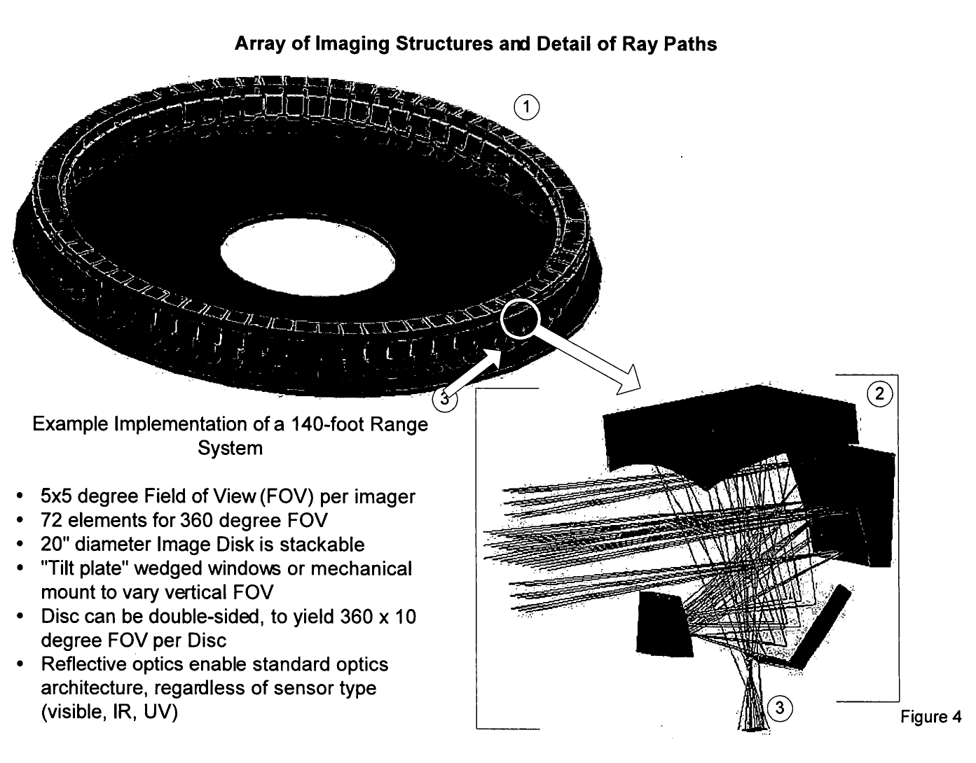

### FIG. 4

### Array of Imaging Structures and Detail of Ray Paths

FIG. 4 illustrates the principal light gathering physical components. This nominal array is designed for a 140-foot radius trip-line. This means the array will resolve approximately ⅛^{th} of an inch per pixel at 140 feet of range.

Item 1 is a nominal configuration of reflective lenses and imaging chips. This nominal array will provide 360 degrees of azimuth coverage. The disk could be double-sided and then the vertical extent of the design would be 10 degrees instead of 5 degrees.

Item 2 is a blow-up of a nominal reflective lens made up of four elements potentially being made out of plastic or molded glass and finished machined.

Item 3 represents the imaging chip. Item 3 is oriented radially from the center of the disc and is in natural alignment with the other imaging chips on the disc.

### DETAILED DESCRIPTION OF INVENTION

The central feature of this apparatus is the replicable architecture of the individual lens, imaging chip and the portion of the processing architecture assigned to each lens/imaging chip unit (herein referred to as the “Imaging Subsystem”), creating a highly parallel structure of sub-systems. The architecture supports a family of cameras, each designed using more or fewer of the Imaging Subsystems, chosen so that resolution and field of view sufficient to the target application are delivered by the apparatus. Sufficient resolution and field of view are defined as that which is required to enable fully automated threat detection and the delivery of alerts to a responsive resource with enough temporal margin to enable interdiction or corrective action.

Key to the utility of this invention is the low-cost reflective lens component of the Imaging Subsystem. Although the core catoptric lens has not changed since Isaac Newton, the implementation of the reflective lens in this apparatus is unique. Computational imaging is used to extend the depth of field of the reflective lenses and to create a depth map of the objects in the field of view. The depth map range information extends the motion detection processing to the creation of a velocity vector map. The velocity vector map, along with computation for estimations of size and ground-coupled stability, is the basis for a novel assessment technology that will categorize threats with an unprecedented level of confidence. [See FIG. 2]

This low-cost reflective lens technology is capable of working to the full capability of the current technology megaPixel imaging chip. Each lens is coupled to a CMOS imaging chip of significant resolution (>9 MegaPixels). The current CMOS imaging chip has a large pixel count and is built with a new level of integrated image processing technology on the chip itself. The imaging chip feeds detected video to a new generation of FPGA elements that enable an extremely large computational machine with significant local storage to be packaged in a minimal physical area with a very low power requirement. [See FIG. 1]

The implementation of computational imaging using reflective lenses involves the unique insertion of the coded filter. In traditional refractive lenses, the coded aperture filter is a physical disk of opaque material inserted into the optical path, usually by placing the filter ahead or behind the lens itself. The holes in the filters must be larger than the diffraction limit and optimally placed to enable the efficient mathematical process of image feature enhancement, typically, depth of field extension and range mapping. But for a reflective lens, the filters can be built into the surface of the reflectors themselves. There are many means of implementation. Molded glass reflectors could be directly micro-machined on the surface to effect spatial of even wave-coded filters. Eventually, the ambition to lower cost will machine the filters directly into the surface of plastic molds that will accurately transfer the filter to each lens.

The utility provided by an automation alert system is judged by the time of warning provided or the trip-line distance from the protected area. As a general statement, being able to sufficiently read a license plate is sometimes considered a threshold of image resolution. The consensus among public safety officials is that 500 feet is a minimum trip-line distance. To be effective, the system must detect threats and provide an alert with enough time allowed for a response before the threat has advanced to close the effective distance between the threat and the protected area to less than 500 feet. A resolution analysis shows us that the lens system must be able to resolve to at least ⅛^{th} of an inch per pixel at 700 feet. If each imager provides 2,500 pixels, then approximately 180 lens-imager units will be required to provide a 180° panoramic view. Two such units placed back to back could provide 360° coverage.

This system by design requires usable connective bandwidth, but does not attempt to deliver captured video images to a head-end for processing. All significant processing is done in the camera. Instead, this system delivers, for further analysis, identified threats not yet fully classified as imminently hostile; and alerts, generated when the threat has violated some established geographical boundary (failed to stay outside of the fence), failed some operational procedure (left a package near the gate), violated some restriction (vehicle too large), or broken some other specifically defined rule for the current application.

When alerts are detected and the system is equipped with sufficient bandwidth, clear images of the qualifying alert assessments will be delivered instantly. The system will also make use of minimal bandwidth accurate delivery connections to deliver textual messages of the alert to reactive personnel. This means that guards along the perimeter might get exact physical locations and a text-based description of the violation and, if bandwidth permits, pictures of the incident. Because the system has significant local storage, low-latency notification to key reactive personnel can prompt remote viewers to use other or even local higher data rate connectivity to examine or review the full video history of the alert.

The camera system is novel in the way it captures image data. The system employs a plural format image capture process. A set of video management tools has been created that simultaneously support multiple image data formats. The camera system offers remote viewers a standard 320 by 240 video image that can be controlled in tilt, pan and zoom. Without moving parts, the system has a capability to provide a nominal 10× optical zoom feature. Simultaneous with this steered-beam capture technology the system captures mega-pixel images that can be up to full panoramic in scope. If detections are made that don't fit well into the automated processes, or if remote human operators need to use the system for intelligence-gathering operations then, given a required minimum bandwidth, the system will allow multiple simultaneous remote viewers to tilt, pan and zoom over the full panoramic scene on a non-interfering basis.

Unique to this imaging sub-system is the way in which a remote viewer is enabled to traverse around the imaging array by tilt, pan and zoom functions. The very large image array is made up of multiple individual imaging chips (imager), where each imager has a nominal image array size of 2,500 by 3,500 pixels, while a typical standard video image is 320 by 240 pixels. (Again this is nominal, the pixel arrays could be of arbitrary dimension).

Using the unique capabilities of the CMOS image array to skip rows and columns or alternatively to “bin” rows and columns, wide angle views will be created by selecting the rows and columns of the image as a smooth distribution over the entire area of the array. [See FIG. 3] That is, to create a 320 by 240 image with the widest aperture or the widest field of view (i.e. zoomed all the way out), the rows and columns of the outermost “ring” of the image array will be the outermost “ring” of the created image. Then approximately 10 rows and columns will be skipped (or binned and averaged) and another ring will be selected. This process will be repeated until approximately 320 columns and 240 rows are created for the product image. This technique actually changes the aperture angle in much the same way as a zoom lens does.

To zoom in, the outermost ring of the created image is taken from a more interior ring of the image array and then fewer of the rows and columns are skipped or binned to create the next ring in the product image. In the limit of this selected component optical zoom, the 320 by 240 image is created using neighboring pixels in the image array. Of course, at the display monitor the presented image can be mapped from created pixel to multiple pixels for a “digital” zoom effect.

To pan the image, the image array selection of rings is chosen around a different center in the image array. As the chosen row and column rings near the edge of an individual image array the images are created using the data from columns and rows of the neighboring image arrays, if necessary. Thus the pan capability is nearly a full 180°. Similarly, tilt can be realized by moving the center of the image selection grid up or down the array.

Live viewers and those viewing archived data can indicate or mark a scene. Those scenes with marks will be treated by the system as “directed alerts” and can be revisited at any time to be examined in very high fidelity. The system will select the nearest large format images on either side of the mark-time and allow the viewer to see the images in broad, wide-angle format. The viewer can then zoom in to very fine detail and examine the features of the scene. No matter what the zoom setting of the video stream during capture, the full wide-angle resolution image is captured simultaneously with the video image, but at a lower frame rate (the detection rate). The low frame rate data is available to provide wide-angle reference to reveal relevant activity and also fine-image detail to reveal exact details of a scene.

The deployed system can be managed remotely by several different system-wide management utilities. Thus the system has hierarchical management capabilities that allow the system to be used in geographical areas composed of many local management entities while allowing these local interests to locally manage sensitive data. All of the data can be routinely managed within local departments. But when or if there is a situation that covers a wider area of concern across multiple departments, the system will allow, with proper managed permissions, access across parallel entities. Thus, video and data on a fleeing suspect who drives from one town to the next can be passed on so that those ahead of him can be given a view of the live or recorded situation; and they may be properly warned or alerted to the situation before the suspect actually enters their region.

In application, the camera system could be configured to deliver full fidelity images of up to 800×600 to local recording at 30 fps. Simultaneously, the system could be configured record a large format image from each of the imaging chips stitched together to form a full panoramic image. In addition the system may provide a standard video image to a remote live viewer at the bandwidth dependent rate. Remote viewers with appropriate management authorization will have the capability to adjust tilt, pan and zoom settings for both the live and recorded data.

It is well known in the prior art how to use refractor lenses and a coded spatial filter in conjunction with high-pixel count imaging chips to implement a computational imaging system. It is not well known how to use a reflector lens with a spatial or wave-based filter machined or cast into the surface of the reflector as a basis for a computational imaging system.

It is well known in the prior art of video recording how to collect video data via a camera. It is also well known in the prior art how to store this data locally and how to stream video back to a location using a wired or wireless capability. What is not well known is how to disseminate alert or warning information in an environment where only minimal wireless networks have coverage.

It is also not well known how to store video images by storing a complex data structure that includes full panoramic images stored at a detection rate and larger images of each alert stored at the alert monitoring rate. Video transmitted to remote live monitors is usually sized and updated at a frame rate to fit the available bandwidth, but is not stored. A remote viewer that asks to review previously transmitted video can ask to have the video retransmitted and the system will recreate the video stream from the higher fidelity alert video locally stored.

It is also well known in the prior art how to change the view of a camera by means of a mechanical tilt/pan unit and an optical lens for changing zoom. It is not well known how to implement a tilt/pan/zoom apparatus that does not require mechanical movement or devices.

It is also not well known how to build a system of reflective lenses and imaging chips to form a panoramic video system that enables an actual tilt, pan and zoom functionality without any moving parts.

What is claimed is:

1) An apparatus and method for implementing an automated imaging and threat detection and alert system. Said apparatus and method are based upon a panoramic imaging system and computing to automate the detection, localization, tracking and assessment of moving targets to identify threats and alert designated agencies or personnel. Said apparatus and method comprising:
a) a new technology megapixel imaging chip with extremely small feature size (pixels which are less than 5 micrometers and typically less than 2 micrometers across or on a diagonal), which have the ability to generate images of arbitrary size centered around a point which is programmable on a frame-by-frame basis;
b) a panoramic fixed lens system composed of individual lens elements, each lens element coupled to its own imaging chip;
c) a processor or processors capable of providing at least 1.5 G MACs (Multiple-Add instructions) per imaging chip;
d) a means to implement a method for effective target detection, tracking and assessment using passive ranging technology;
e) a software process for implementing a weighted function to automatically assess detected motion to categorize a hostile threat;
f) a software process for implementing a weighted function to automatically determine when a threat requires an alert to be generated to designated threat assessment and response center or personnel;
g) a software process which implements the alerting function to designated threat assessment and response center or personnel;
h) a means by which multiple alerted or observing personnel will be electronically delivered by wire (or wirelessly) alerting text and appropriately sized still images or video of arbitrary selection from full panoramic to extreme telephoto
i) an apparatus for wired or wireless connectivity to designated threat assessment and response center or personnel;
j) a software process for monitoring the status of a processed alert to ensure appropriate response or acknowledgement.

2) The panoramic fixed lens system of claim 1, comprising:
a) an array of multiple imaging chips with the ability to replicate the functions of tilt, pan and zoom with no moving parts through a method of changing the selection (choosing different rows and columns on the imaging surface) of pixels to compose said image, as well as the center point of each image, on a frame-by-frame basis;
b) an array of multiple fixed lenses arranged in a circular arc, associated with said array of multiple imaging chips, located close enough to the array of imaging chips to create an image field composed of the images of many imaging chips arranged radially around the same geometric center;
c) another array, similar to the aforementioned array, displaced vertically to extend the vertical aperture of the panoramic view;
d) an array of multiple fixed lenses where the lenses are refractor lenses;
e) an array of multiple fixed lenses where the lenses are reflector lenses;
f) a method for incorporating computational imaging (e.g, Wave Front Coding) in each of the lenses within said array of fixed lenses, to enable the extension of depth of field and the calculation of distance to subjects within each pixel of the image generated by aforementioned imaging chips.

3) The means of claim 1 to create an architecture of processors or processes implemented in a larger array of processing elements providing:
a) a means to coordinate the simultaneous processing of the image outputs of each imaging chip;
b) a means to coordinate the simultaneous processing of the overlapped images to create a working panoramic image surface that accurately represents the entire panoramic scene;
c) a means to coordinate the simultaneous linked processing of successive image surfaces in a First-In, First-Out (FIFO) structure providing a configurable short-term memory for comparison of successive images;
d) a means to coordinate the simultaneous but independent processing of successive image surfaces in short-term memory to detect motion uniformly and simultaneously across the large panoramic scene;
e) a means to coordinate the simultaneous but independent processing of images in short-term memory to make optimum use of computational imaging (e.g., wave front coding) to extend the depth of field of the images and to detect the passive range for each pixel as a means to add detail and accuracy to the detection of motion;
f) a means to coordinate the simultaneous but independent processing of the detected motion to create a schedule of isolated tracks;
g) a means to coordinate the simultaneous but independent processing of detected tracks to create a table of characteristics to include parameters such as a velocity vector, estimate of size, an estimate of center of mass, a measure of ground coupling;
h) a means to coordinate the simultaneous but independent processing of external independent image requests from viewers tasked with augmenting the automated processes of detection and classification;
i) a means to create images of a view as requested by an external reviewer, configurable in pan, tilt, and zoom (create images with a designated center, and a selection of pixels selected from across the imaging surface);
j) a means to create the requested images in various sizes, resolution and frame rate in response to the available bandwidth and urgency.

4) The means of claim 1 to implement a method of processing the image surface built using the images generated by the aforementioned imaging chips, for effective target detection, tracking and assessment, said method implemented within multiple software processes, comprising:
a) a method of building an image surface built from the images produced by individual image chips, each attached to an individual fixed lens, each of which is arranged in a geometrically centered array;
b) a method for storing said images as frames in a buffer for use in creating “video” or for comparing to other image frames;
c) a method for comparing successive panoramic images, by comparing corresponding blocks of designated size within successive panoramic images, in order to determine whether changes in content have occurred between said successive images;
d) a method for comparing image frames arranged in time-sequenced order as short-term memory, e.g. as a FIFO;
e) a method for adaptively configuring the depth of the FIFO used as short-term memory based on initial configuration, relative activity in the scene, the status of stability of the current “track” activities;
f) a method for comparing successive frames within the FIFO to detect changes in content that might be basis for “motion detection”;
g) a method for estimating the size of the detection and the apparent center of mass of the detection and creating a map of those values;
h) a method for correlating the content basis for motion detection with the range data per pixel from the computational imaging process across the image surface;
i) a method for evaluation of any said change in content to evaluate whether there has been motion of an object, change in distance, change in size, or change in location of said object;
j) a method for determining speeds and accelerations for any motion detected in aforementioned moving objects;
k) a method for building a map of velocity vectors for each aforesaid moving object on a real-time basis;
l) a method of comparing the detection map of velocity vectors with the map of estimated size and the centers of mass maps to create a detection data map;
m) a method of comparing the data maps to a threshold function process that will categorize the detections as a track, a threat or an alert.

5) The means of claim 1 to implement a weighted function algorithm designed to automatically assess motion detected by aforesaid motion detection processes, comprising:
a) a method for assigning values to detected motions of objects, changes in distance to an object, changes of an object's apparent size, changes in an object's location, changes in the object's velocity and the object's computed trajectory;
b) a method for processing said values, now called threat assessment components, to an overall weighted value called the “Threat Assessment Value”;
c) a method for comparing the Threat Assessment Value to a given threshold to categorize the object as a threat and assigning an identifier to said object.

6) The means of claim 1 to implement a weighted function algorithm designed to automatically evaluate threats identified by aforesaid assessment processes to determine if an alert should be generated by the system, a software construction comprising:
a) a method for tracking identified threats against a set of track parameters;
b) a method for assigning values to the deviations of the tracked threats from the “safe” track parameters, such a deviating threat will be termed a “Hostile Threat.”

7) The means of claim 1 to implement an alerting function to communicate the detection and classification of a Hostile Threat from the aforesaid threat evaluation process as an alert to a designated second-level response center or personnel, comprising:
a) a method for determining the means and technique of sending the alert;
b) a method for determining the projected latency of the various communication options relative to the seriousness of the alert;
c) a method for determining to which response center or personnel to send said alert depending on the alert level, the available communication options and the capabilities of the response center or personnel;
d) a method for making the optimum selection of message type (i.e. text, still images or video) and communication channel (latency considerations, bandwidth, security);
e) a method for matching the communications selection with the capabilities of the response center or personnel.

8) The means of claim 1 for communicating aforesaid alert to the designated response center or personnel as determined by the aforesaid alerting function, comprising:
a) an apparatus for communicating, via wired or wireless link, to stations or access points within the range of said apparatus;
b) a method for encoding said alert for transmission on said apparatus;
c) a method for determining that said transmission was received by the target station or access point
d) a method for reassessing the alert to manage the response status.

9) The means of claim 1 to implement a method for processing the image surface built using the images generated by the aforesaid Imaging Subsystem, to effectively create specific images positioned across the panoramic scene in response to requests made by external reviewers to get real-time or near real-time visual data to aid in the prosecution of alerts, comprising:
a) a method to index and position the panoramic image surface relative to GPS and electronic environmental sensors in order to create a relative positioning perspective for external users;
b) a method to create an image with a designated center, of either user-selected size or a size related to the bandwidth of the external requester;
c) a method to implement a “pan” and “tilt’ by changing the location within the imaging surface of the “point” around which the chosen image of specified size is centered;
d) a method to implement a “zoom” function by changing the selection (choosing different rows and columns on the imaging surface) of pixels to compose said image, by “skipping” rows and columns or “binning” (averaging) rows and columns;
e) a method for abstracting created images to reduce their bandwidth requirement, when the total data bandwidth requirement of the external users at the same priority level exceeds the capacity of the installed system;

10) The means of claim 1 for managing the status of a processed alert to reduce unnecessary communication bandwidth consumption and to maintain alert focus, comprising:
a) a method for monitoring the alert and the maintenance of the Threat activity;
b) a method for monitoring the response center or personnel and the management of the alert;
c) a method for reasserting the alert if the response center or personnel fail to effectively compromise the alert;
d) a method for reassessing the communications means and the selection of the response center or personnel if the processing of the alert does not fall within the allotted alert window.
